(19) United States
(12) Patent Application Publication
(10) Pub. No.: US 2015/0033269 A1
(43) Pub. Date: Jan. 29, 2015

(54) SYSTEM AND METHOD FOR DISPLAYING AVAILABILITY OF A MEDIA ASSET

(71) Applicant: THOMSON LICENSING, Issy de Moulineaux (FR)

(72) Inventors: Troy AZMOON, Carlsbad, CA (US); Juan M. NOGUEROL, Gardena, CA (US)

(21) Appl. No.: 14/338,256

(22) Filed: Jul. 22, 2014

Related U.S. Application Data
(60) Provisional application No. 61/986,717, filed on Apr. 30, 2014.
(60) Provisional application No. 61/858,493, filed on Jul. 25, 2013.

(51) Int. Cl. H04N 21/4627; H04N 21/431; H04N 21/254; H04N 21/2665; H04N 21/462

(52) U.S. Cl. CPC H04N 21/4627; H04N 21/2665; H04N 21/4622; H04N 21/2541; H04N 21/431
USPC 725/59

(57) ABSTRACT

A method and apparatus for displaying information in a user interface is provided. For a class of media assets including at least one sub-class, a level of access to each of the at least one sub-class is determined. Format information for the class of media assets based on the determined level of access for each of the at least one sub-class is generated. The format information includes at least one characteristic identifying the determined level of access for each of the at least one sub-class. A user interface is generated to include media asset identifiers, the media asset identifiers each identifying a respective one of the at least one sub-class and being displayed in the user interface based on the format information.

### CROSS REFERENCE TO RELATED APPLICATIONS

This application claims the benefit of U.S. Provisional Patent Application No. 61/986,717, filed on Apr. 30, 2014 and U.S. Provisional Application No. 61/858,493, filed on Jul. 25, 2013, which is hereby incorporated by reference herein in its entirety.

### FIELD OF THE DISCLOSURE

The present disclosure generally relates to digital content systems and, more particularly, displaying availability of a media asset.

### BACKGROUND

Home entertainment systems, including television and media centers, are converging with the Internet and providing access to a large number of available sources of content, such as video, movies, TV programs, music, etc. This expansion in the number of available sources necessitates a new strategy for navigating a media interface associated with such systems and enabling access to certain portions of media content being consumed by the user.

With this expansion, a plethora of content distribution sources have populated the landscape. These content distribution sources selectively provide different types of multimedia content to users via various distribution channels including cable system video-on-demand (VOD) and access agreements between the user and the content distributor. One example of an access agreement includes the ability of a user to acquire temporary access to a particular piece of multimedia content. This is conventionally known as a rental agreement or pay-per-view agreement whereby a user pays a certain price, which grants the user access to a particular piece of multimedia content for a predetermined duration. Another type of access agreement includes the ability to purchase the particular piece of media content outright to own in perpetuity. This is typically known as a purchase agreement. With the advent of internet connected set top boxes being deployed by cable operators as well as the increased ability of other network connected devices that are connectable to a television, users have greater access to various content distribution sources that distribute their content according to one of these types of access agreements. While the access to the number of pay-per view offerings has increased, there has not been an equal increase in usability improvements for users who consume the content from these providers under these arrangements. Often times, the content acquired represents a subset of a content class (e.g., a season of a television show being the content and the class being all seasons of that show) and a user is unable to decipher what subsets of the content class are accessible at any given time. The result is the user (e.g., consumer) may expend time and effort comparing what is accessible, what is available, and what is unavailable.

### SUMMARY

A method and apparatus for displaying information in a user interface is provided. For a class of media assets including at least one sub-class, a level of access to each of the at least one sub-class is determined. Format information for the class of media assets based on the determined level of access for each of the at least one sub-class is generated. The format information includes at least one characteristic identifying the determined level of access for each of the at least one sub-class. A user interface is generated to include media asset identifiers, the media asset identifiers each identifying a respective one of the at least one sub-class and being displayed in the user interface based on the format information.

### BRIEF DESCRIPTION OF THE DRAWINGS

These and other aspects, features, and advantages of the present disclosure will be described or become apparent from the following detailed description of embodiments, which is to be read in connection with the accompanying drawings.

In the drawings, wherein like reference numerals denote similar elements throughout the views:

FIG. 1 is a block diagram of a system for delivering video content in accordance with various embodiments;

FIG. 2 is a block diagram of a set-top box/digital video recorder (DVR) in accordance with various embodiments;

FIG. 3A is a tablet and/or second screen device in accordance with various embodiments;

FIG. 3B is a remote controller in accordance with various embodiments;

FIG. 4 is a block diagram illustrating the hierarchical organization of media assets in accordance with various embodiments;

FIG. 5 is a block diagram of a system in accordance with various embodiments;

FIG. 6 is a block diagram of a receiving device in accordance with various embodiments;

FIG. 7 is a flow diagram detailing an implementation in accordance with various embodiments;

FIG. 8 is a user interface display image generated in accordance with various embodiments; and

FIG. 9 is a flow diagram detailing an implementation in accordance with various embodiments.

It should be understood that the drawings are for purposes of illustrating concepts of the disclosure and are not necessarily the only possible configurations for illustrating the disclosure.

### DETAILED DESCRIPTION

It should be understood that the elements shown in the figures may be implemented in various forms of hardware, software or combinations thereof. These elements can be implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for instructional purposes to aid the reader in understanding the principles of the disclosure, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a combination of circuit elements that performs that function or software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

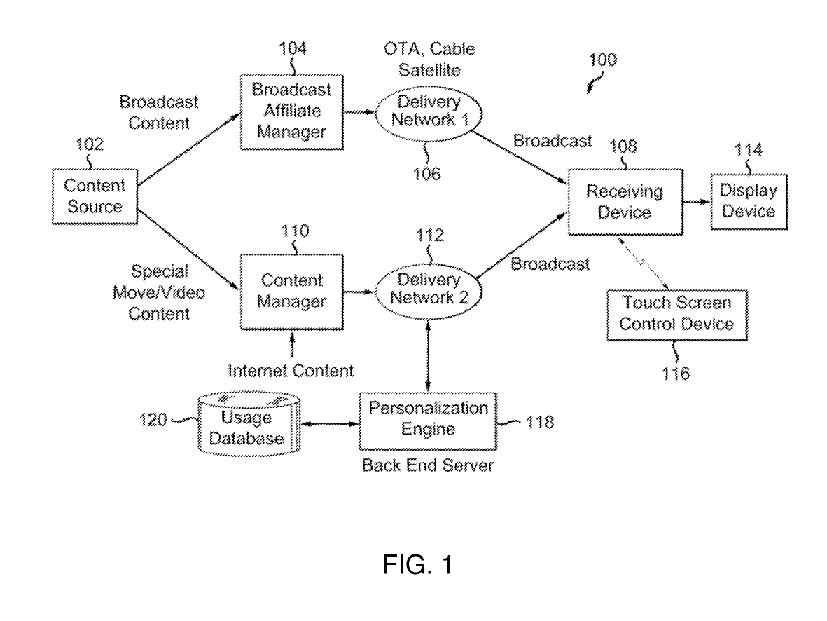

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a delivery network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content may subsequently be searched by the user. It is to be appreciated that the receiving device 108 can take many forms and may be embodied as a set top box/digital video recorder (DVR), a gateway, a modem, etc. Further, the receiving device 108 may act as an entry point, or gateway, for a home network system that includes additional devices configured as either client or peer devices in the home network.

A second form of content is referred to as special content. Special content may include content delivered such as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

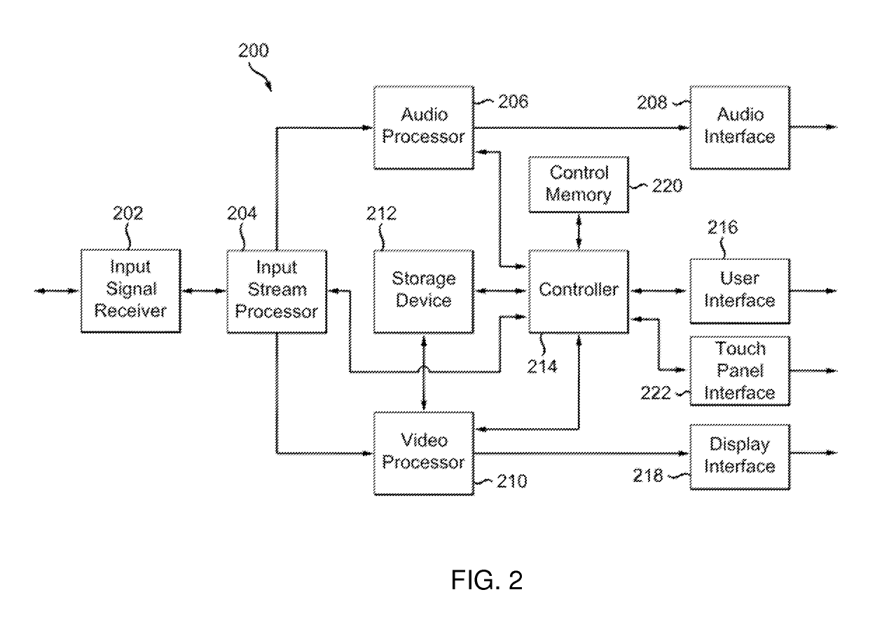

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display, an advanced 3-D display, etc.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries (as discussed below), or may be a portion of the video content that is delivered to the display device 114. The touch screen control device 116 may interface to receiving device 108 using a signal transmission system, such as infra-red (IR) or radio frequency (RF) communications and may include standard protocols such as infra-red data association (IRDA) standard, Wi-Fi, Bluetooth™ and the like, or any other proprietary protocols. Operations of touch screen control device 116 will be described in further detail below.

In the example of FIG. 1, system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118. In the present example, the back end server 118 (as well as the usage database 120) is connected to the system 100 and accessed through the delivery network 2 (112). In an alternate embodiment, the usage database 120 and backend server 118 may be embodied in the receiving device 108. In a further alternate embodiment, the usage database 120 and back end server 118 may be embodied on a local area network to which the receiving device 108 is connected.

Turning now to FIG. 2, a block diagram of an embodiment of a receiving device 200 is shown. Receiving device 200 may operate similar to the receiving device described in FIG. 1 and may be included as part of a gateway device, modem, set-top box, or other similar communications device. The device 200 shown may also be incorporated into other systems including an audio device or a display device. In one embodiment, the receiving device 200 may be a set top box coupled to a display device (e.g., television). The receiving device 200 may also be a portable device such as a tablet computer and/or a smartphone.

In the receiving device 200 shown in FIG. 2, the content is received by an input signal receiver 202. The input signal receiver 202 may be, for example, one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as a compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony™/Philips™ Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (RW), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results (e.g., in a three dimensional grid, two dimensional array, and/or a shelf as will be described in more detail below).

The controller 214 is interconnected via a bus to several of the components of the device 200, including the input stream processor 204, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the grid, array and/or shelf display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory 220 may also store a database of elements, such as graphic elements containing content. The database may be stored as a pattern of graphic elements, such as graphic elements containing content, various graphic elements used for generating a displayable user interface for display interface 218, and the like. In some embodiments, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device, more than one memory circuit communicatively connected or coupled together to form a shared or common memory, etc. Still further, the memory may be included with other circuitry, such as portions of bus communications circuitry, in a larger circuit.

Optionally, controller 214 can be adapted to extract metadata, criteria, characteristics or the like from audio and video media by using audio processor 206 and video processor 210, respectively. That is, metadata, criteria, characteristics or the like that is contained in the vertical blanking interval, auxiliary data fields associated with video, or in other areas in the video signal can be harvested by using the video processor 210 with controller 214 to generate metadata that can be used for functions such as generating an electronic program guide having descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, provide security that identifies the source of an audio signal, or perform some other service. Furthermore, metadata, criteria, characteristics or the like, to support the actions listed above can come from a network source and be processed by controller 214.

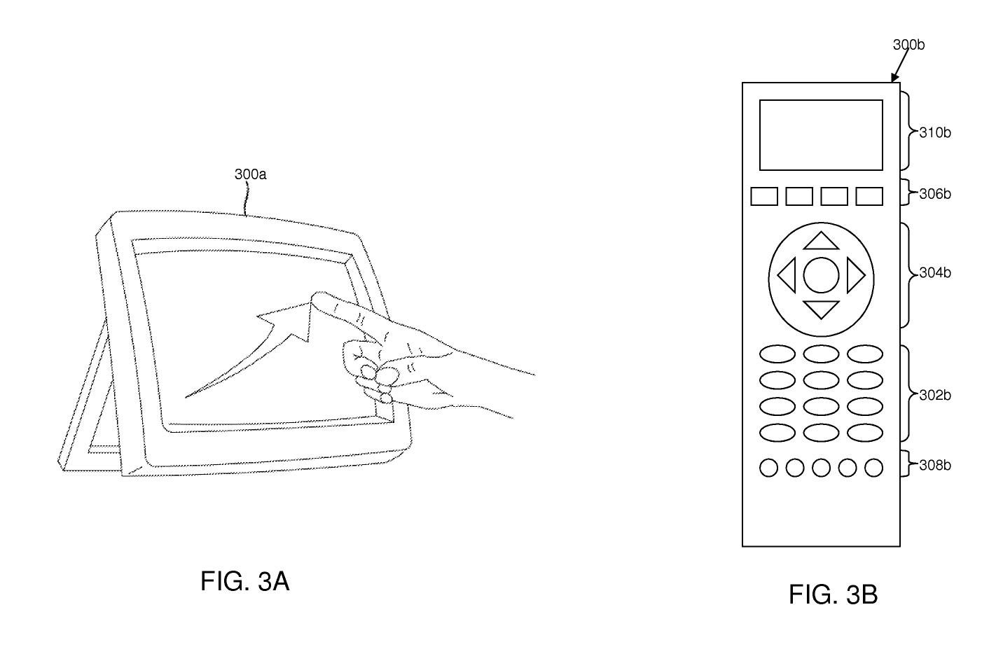

FIGS. 3A and 3B represent two input devices, 300a and 300b (hereinafter referred to collectively as input device 300) according to various embodiments, for use with the system described in FIGS. 1 and 2. The user input device 300 enables operation of and interaction with the user interface process according to various embodiments. The input device may be used to initiate and/or select any function available to a user related to the acquisition, consumption, access and/or modification of multimedia content. FIG. 3A represents one example of a tablet or touch panel input device 300a (e.g., the touch screen device 116 shown in FIG. 1 and/or an integrated example of media device 108 and touch screen device 116). The touch panel device 300a may be interfaced via the user interface 216 and/or touch panel interface 222 of the receiving device 200 in FIG. 2. The touch panel device 300a allows operation of the receiving device or set top box based on hand movements, or gestures, and actions translated through the panel into commands for the set top box or other control device. This is achieved by the controller 214 generating a touch screen user interface including at least one user selectable image element enabling initiation of at least one operational command. The touch screen user interface may be pushed to the touch screen device 300a via the user interface 216 and/or the touch panel interface 222. In an alternative embodiment, the touch screen user interface generated by the controller 214 may be accessible via a webserver executing on one of the user interface 216 and/or the touch panel interface 222. The touch panel 300 may serve as a navigational tool to navigate the grid display. In some embodiments, the touch panel 300a will additionally serve as the display device allowing the user to more directly interact with the navigation through the grid display of content. The touch panel device 300a may be included as part of a remote control device 300b containing more conventional control functions such as activator and/or actuator buttons such as is shown in FIG. 3B. The touch panel 300a can also include at least one camera element and/or at least one audio sensing element.

In various embodiments, the touch panel 300a employs a gesture sensing controller or touch screen enabling a number of different types of user interaction. The inputs from the controller are used to define gestures and the gestures, in turn, define specific contextual commands. The configuration of the sensors may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motions, such as a swing. Gestures are interpreted in context and are identified by defined movements made by the user. Depending on the complexity of the sensor system, only simple one-dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be placed in a different spot and used for channel up/down. In this way specific gesture mappings may be used. For example, the touch screen device 300a may recognize alphanumeric input traces which may be automatically converted into alphanumeric text displayable on one of the touch screen devices 300a and 300b or output via display interface 218 to a primary display device.

FIG. 3B illustrates another input device 300b according to various embodiments. The input device 300b may be used to interact with the user interfaces generated by the system and output for display by the display interface 218 to a primary display device (e.g., television, monitor, etc.). The input device of FIG. 3B may be formed as a conventional remote control having a 12-button alphanumerical keypad 302b and a navigation section 304b including directional navigation buttons and a selector. The input device 300b may also include a set of function buttons 306b that, when selected, initiate a particular system function (e.g., menu, guide, DVR, etc.). Additionally, the input device 300b may also include a set of programmable application specific buttons 308b that, when selected, may initiate a particularly defined function associated with a particular application executed by the controller 214. As discussed above, the input device may also include a touch panel 310b that may operate in a similar manner as discussed above in FIG. 3A. The depiction of the input device in FIG. 3B is merely an example and the input device may include any number and/or arrangement of buttons that enable a user to interact with the user interface process according to various embodiments. Additionally, it should be noted that users may use either or both of the input devices depicted and described in FIGS. 3A and 3B simultaneously and/or sequentially to interact with the system.

In some embodiments, the user input device may include at least one of an audio sensor and a visual sensor. In these embodiments, the audio sensor may sense audible commands issued from a user and translate the audible commands into functions to be executed by the user. The visual sensor may sense the user(s) presence and match user information of the sensed user(s) to stored visual data in the usage database 120 in FIG. 1. Matching visual data sensed by the visual sensor enables the system to automatically recognize the user(s) present and retrieve any user profile information associated with those user(s). Additionally, the visual sensor may sense physical movements of at least one user present and translate those movements into control commands for controlling the operation of the system. In these embodiments, the system may have a set of pre-stored command gestures that, if sensed, enable the controller 214 to execute a particular feature or function of the system. A type of gesture command may include the user waving their hand in a rightward direction which may initiate a fast forward command or a next screen command or a leftward direction which may initiate a rewind or previous screen command depending on the current context. This description of physical gestures able to be recognized by the system is merely an example and should not be taken as limiting. Rather, this description is intended to illustrate the general concept of physical gesture control that may be recognized by the system and persons skilled in the art could readily understand that the controller may be programmed to specifically recognize any physical gesture and allow that gesture to be tied to at least one executable function of the system.

According to various embodiments, the present system can generate user interface (UI) display images that provide users with information associated with media assets that are accessible to and by a user at a given time. In particular, the UI display images can provide information associated with at least one type of media asset class. A media asset class includes a plurality of individual media assets, each media asset within the class is referred to throughout the description as a sub-class. Additionally, it is possible for a respective sub-class to have further sub-classes associated therewith.

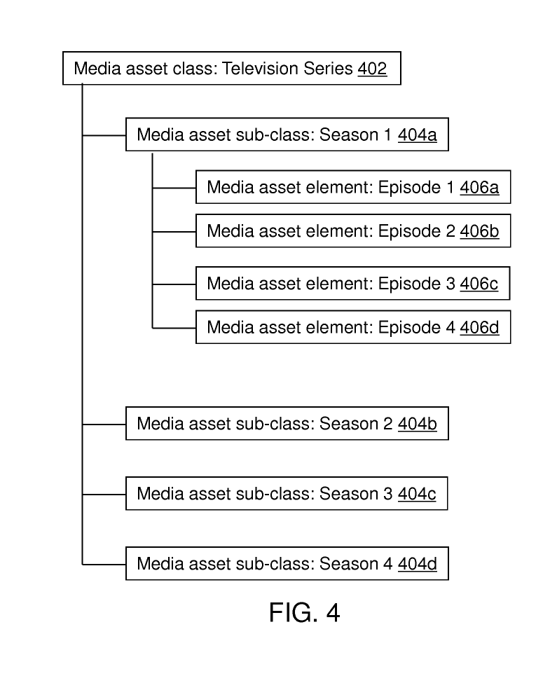

FIG. 4 illustrates an example of a media class hierarchy according to various embodiments. In FIG. 4, a class of media assets may be a series for a particular television show 402. A sub-class of media assets associated with the series for the particular television show may represent a number of seasons during which the show has been broadcast for consumption by users. Sub-classes of media assets are referred to generally using reference numeral 404. As shown in FIG. 4, the particular television show 402 has been broadcast for four (4) seasons. Thus, the sub-classes of media assets include “season 1” 404a, “season 2” 404b, “season 3” 404c and “season 4” 404d. Each sub-class 404 includes at least one element 406. The elements 406 that are included in each sub-class represent the individual episodes that make up the respective season. Sub-class 404a includes episode elements 406a-406d, which represents episodes 1-4 of season 1. The illustration shown herein describes only elements being present in the first sub-class 404a. However, this is done for purposes of example only and to illustrate the hierarchical organization relevant to the present disclosure. Sub-classes 404b-d can also include episode elements, which are not shown in FIG. 4.

Additionally, the media class is described as a television series for purposes of example only. It should be understood that the class of media assets may be grouped and/or otherwise organized using any type of descriptive term with which multiple types of individual media assets may be grouped. In some embodiments, for example, the media asset class can be representative of multimedia projects associated with or concerning a particular director and sub-classes could include individual movies directed by the particular director. In some embodiments, for example, the media asset class may represent multimedia projects including or related to a particular actor and sub-classes could include all the movies and/or television shows in which the actor appears.

As used herein, an individual media asset may include any type of multimedia content that includes at least one of audio data, visual data, and audiovisual data. Additionally, a media asset may be formed as one or more data files in any file format able to be received, decoded, processed and output for display on a display device. Furthermore, a media asset may include a link to a location on a network from which the media asset may be selectively acquired and viewed in real-time (e.g., streaming video files). In various embodiments, a media asset may include a channel over which a plurality of different multimedia data is transmitted for viewing by a user. The above description of a media asset is provided for example only and should not be construed as limiting. Rather, a media asset as used herein may be any type of multimedia data that may be selected by a user for processing and display on a display device.

In particular, according to various embodiments, the user interface generated can provide users with information about both the level of access and availability for particular media asset classes as well as media asset sub-classes and elements of each sub-class. A level of access may indicate that the user has at least one type of access to the sub-classes and/or elements of the sub-classes. Types of access levels can include, but are not limited to, temporary access, full access, unavailable at a current time, available in conjunction with an access agreement, and available but not under current access agreement between user and content provider. Temporary access may include a rental agreement or pay-per view agreement as known in the art. Full access may include one of a copy being stored locally and/or a copy retrievable on-demand via a streaming service or the like. Unavailable at a current time can indicate that the sub-class and/or elements of the class of media assets exists but the user cannot acquire them at the current time, for example, due to restrictions put in place by the content provider. Media asset sub-classes and/or elements may be indicated as available should the user agree to terms of an access agreement—this can be, for example, a monthly subscription fee. Additionally, the level of access may indicate that the content provider has the content available but based on a present access agreement, the user cannot access the content. This can suggest that the user needs to modify their access agreement should they want access to the content.

Each media asset class may be associated with a respective media asset class identifier. Additionally, respective media asset sub-classes may be associated with respective sub-class identifiers, and the individual elements that make up each media asset sub-class may also be associated with respective element identifiers. A user can be notified as to their ability to access particular media classes, sub-classes and/or elements by automatically modifying a visual cue associated with the respective type of identifier. Additionally, each type of identifier can be modified to include one or more visual cues, each visual cue providing a different information item to the user.

In various embodiments, the system can generate a user interface displaying different media asset classes and their respective sub-classes and/or elements that may be available for access by a user. These assets can be purchased or rented from a media asset service such as, for example, M-GO™. Typically, though a user may know that a particular media asset class includes a plurality of sub-classes, the user may not know if they have access to all sub-classes or even particular elements of particular sub-classes. However, according to various embodiments, the user interface generated by the present system can provide a user with a single view of at least one media asset class and all sub-classes associated with the at least one media asset class such that at least one visual cue associated therewith is modified to provide information to a user about a level of access to each of the sub-classes and elements within the respective subclasses.

Various embodiments for implementing the principles of the present disclosure may be performed on a television or other display, in conjunction with a processor in a television or a set-top box. Various other gateways, servers, routers, and computers, for example, can be used in place of the set-top box or television to provide the information for display. Certain implementations can perform the processing functions largely at a head-end or service provider location, and other implementations can share the processing between local devices (for example, a set-top box or a tablet storing certain information in an app, such as, for example, an M-GO™ app) and remote devices (for example, a Netflix™ service provider).

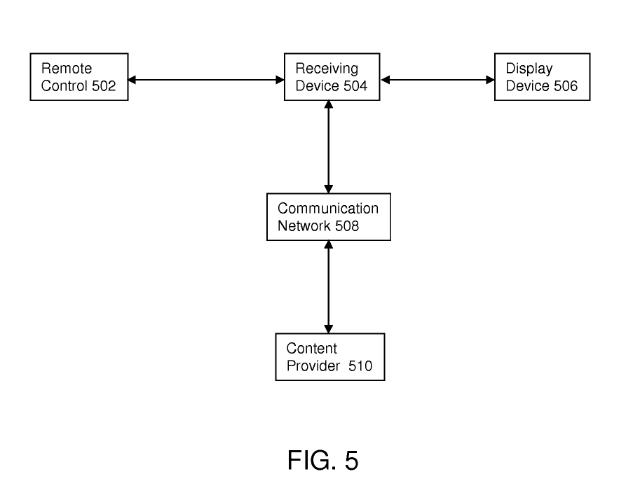

A block diagram detailing a set of components for implementing the system according to various embodiments is shown in FIG. 5. The system shown in FIG. 5 includes a remote control (“RC”) 502, a receiving device (e.g., set-top box) 504 and a display device 506. The receiving device 504 may include all or a portion of the components described above and identified as receiving device 200 in FIG. 2. In operation, the receiving device 504 acquires data representing media asset classes and any associated media asset sub-classes that are available to the user. This acquisition can include a search of media assets provided by a media asset service, for example, and can include a search of local storage devices such as hard drives, DVRs, and catalogs of offline media assets (e.g., music and/or DVDs and/or Blu-ray Discs™). For each located media asset class and sub-class, the receiving device determines a level of access to the media asset class and/or sub-class. The receiving device 504 operates in response to user input provided by a user via the remote control 502. The remote control 502 may be any of the remote control devices discussed above in FIGS. 3A and 3B. The remote control 502 enables the user to provide input and otherwise interact with the system according to various embodiments. Once media asset data is acquired by the receiving device 504, the receiving device 504 may process the media asset data for output to display device 506. The display device 506 may be any type of device able to output media asset data including, but not limited to, any of the display interface 218 for display on display device 114 (FIG. 1), the user interface for output to the user input device 300b (FIG. 3B), and a touch panel interface for output to a touch sensitive display device 300a (FIG. 3A). The depiction of these components as separate is described for purposes of example only and persons skilled in the art would understand that the remote control 502, receiving device 504 and display device 506 may be embodied as a single device or a device that combines any two or all of the three components such as the display screen being incorporated into the remote control, a smart phone, etc. The receiving device 504 is communicatively coupled to the remote control (RC) 502 and to the display device (screen) 506. The receiving device 504 is also communicatively coupled to at least one content provider 510 via a communications network 508. The communications network 508 may be one of a local area network or a wide area network such as the Internet. The content provider 510 may include a plurality of content providers each having a set of media assets, each media asset being viewable for a predetermined amount of time. Exemplary content providers include but are not limited to M-GO™, Amazon™, Netflix™, iTunes™, etc. In general operation, a user employs the remote control 502 to interact with user interfaces generated by the receiving device 504 which are then displayed on display device 506. A respective user interface generated and displayed on the display device 506 enables a user to access the classes of media assets via their respectively associated sub-classes and elements thereof from one of a local storage medium and a particular content provider 510 depending on the determined level of access. More specifically, the user interface can display various identifiers, each identifier associated with a corresponding one of the media asset classes, a corresponding one of the associated media asset sub-classes, or a corresponding one of the elements of respective sub-classes. In response to determining the level of access associated with any of the above, the corresponding identifier can be modified by changing a visual cue associated with the identifier, such that the identifier being displayed with the modified visual cue provides information to the user about the determined access level. The receiving device 404 uses that information to generate user interface displays that are output to the display device 408 for presenting the information associated with the media assets to the user.

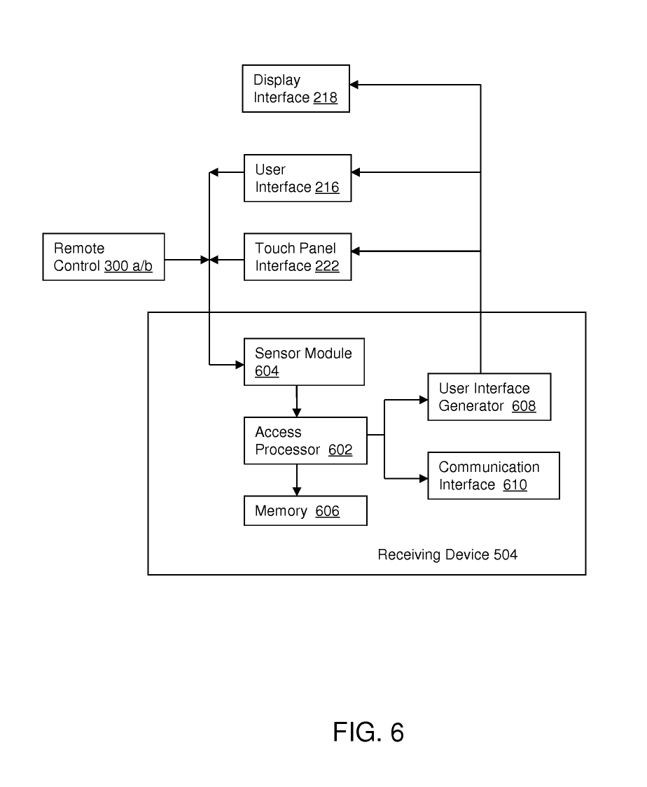

FIG. 6 is a more detailed block diagram of receiving device 504 according to various embodiments. Receiving device 504 can include processors and/or modules that implement the principles of the present disclosure. The receiving device 504 shown in FIG. 6 may include any or all of the components of the receiving device 200 described above with respect to FIG. 2. Moreover, despite the receiving device 504 being shown including certain individual components and/or modules, each of the components and/or modules may be embodied as part of the controller 214 in FIG. 2. In various embodiments, the individual components and/or modules shown in FIG. 6 may be electrically coupled to the controller 214 in FIG. 2 as well as to other elements of FIG. 2 as will be discussed below. In various embodiments, the individual components and/or modules of FIG. 6 may be a standalone circuit included in any electronic device able to generate user interface display images including at least one data field that receives input data from a user.

An access processor 602 includes all necessary computer-implemented instructions to initiate at least one search of at least one source of media assets to identify the various media assets available to a particular user at a given time. The at least one source of media assets able to be searched includes, but is not limited to, at least one of a local storage device, a hard drive, removable storage device, cloud storage services, media subscription services provided by at least one content provider (e.g., M-GO™, Netflix™, etc.), and a catalog of offline media assets (e.g., a listing of DVDs and/or Blu-ray Discs™ owned by the user). In this manner, the access processor 602 automatically compiles media asset data identifying the media assets available to the user performing the search. The search may be initiated in response to user command entered, for example, via one of the remote control devices 300a or 300b. The access processor 602, upon locating the media assets, parses access data associated with each media asset to determine a level of access that the user has to the particular media asset. In various embodiments, the access processor 602 may periodically search and update level of access information associated with respective media classes and assets therein. This advantageously provides the user with the most current information about their ability to access various media assets in a class of media assets.

The access processor 602 is coupled to a memory 606 in which is stored media asset information for each media asset located in the search along with the level of access data associated with each located media asset. The access processor 602 selectively categorizes the located media assets into respective media asset classes. The access processor 602 further creates media asset sub-classes representing a sub-grouping of media assets. Each media asset sub-class includes at least one media asset element representative of a particular media asset content that can ultimately be consumed by the user. Each of the determined media asset classes, sub-classes and respective elements can be associated with a corresponding identifier for display in a user interface being presented to a user on a display device. Additionally, the access processor 602 generates formatting information to be associated with respective identifiers that can be used to selectively change at least one visual cue associated with the respective identifiers thereby changing the manner in which these identifiers will be displayed in the user interface as will be discussed below. The format information includes information used to provide, for example, a visual notification, an audible notification, etc., to a user concerning a level of access to a respective media asset at a given time. Some examples of visual cues that can be used to characterize the media asset identifiers may include a color, a pattern, shading, etc. The visual cue that may be applied to a particular media asset being displayed in a user interface display can depend on one of a determined level of access to the particular media asset. By changing at least one visual cue associated with a respective identifier, the system according to various embodiments can provide the user with at least one information item associated with the one of the media asset class, sub-class or element associated with the visually modified identifier. For example, based on the level of access data, the visual cue of the identifier to be modified may include, but is not limited to, modifying a color of the identifier, modifying a background of the identifier, modifying an area surrounding the identifier, adding an accent character to the identifier, etc.

For example, the access processor 602 may assign a first color (e.g., white) to a media asset identifier corresponding to a media asset sub-class when the access processor determines that a user has full access to all elements in the media asset sub-class. In another example, access processor 602 may assign a second color (e.g., gray) to a media asset identifier corresponding to a media asset class when the access processor determines that there are sub-classes of the media asset class that exist but to which the user has no access. In another example, access processor 602 may modify a media asset identifier corresponding to a media asset sub-class, such that the media asset identifier is a third color (e.g., red) when the access processor 602 determines that the user has access to a sub-set of elements, but not all of the elements in the media asset sub-class. Similarly, instead of, or in addition to formatting media assets using different colors, the access processor 602 may frame the identifier in the user interface with a border having a predetermined pattern which will further notify the user as to an amount of time remaining to access the particular media asset. The above description concerning the application of visual cues is provided for example only and the system may use any number of visual cues for media asset identifiers depending on determined levels of access.

In various embodiments, the access processor 602 may also associate location information with a respective identifier of one of the media asset class, sub-class and element. The location information can include, for example, data representing a location at which the respective media asset may be accessed. This advantageously enables the user to select the identifier to at least one of access the particular media asset or enter into an access agreement with the provider if the user does not currently have access to the particular media asset.

A sensor module 604 is coupled to the access processor 602 and senses input signals generated by, for example, one of user input device 300a in FIG. 3A and/or user input device 300b in FIG. 3B. The input signals may include media asset request data that represents one of a predetermined class of media assets, and information for generating a media asset class, in response to a previous media asset acquisition request generated by the user. Once received by the sensor module 604, the media asset request data is provided to the access processor 602 which initiates a search of all media assets to which the user has consumed to generate the media asset class as discussed above.

In various embodiments, the media asset request may include data identifying a particular television series. In this embodiment, the access processor 602 will search a plurality of local and remote storage devices along with any media subscription services to which the user has access to collect and categorize all media assets related to the particular television series accordingly. In various embodiments, the sub-classes are grouped by seasons of the television series and each sub-class season includes at least one media asset element representing respective episodes that were part of the season. In various embodiments, the media asset request data may include at least one user specified term that is selectively used by the access processor 602 to generate a media class having at least one sub-class based on the user input term. This advantageously enables the user to specify the grouping of media assets of interest. In both of the above embodiments, the access processor 602 determines a user's level of access for all media assets in a particular category in order to generate the formatting information, which can indicate the level of access to respective media assets to the user via the user interface.

A user interface (UI) generator 608 is controlled by the access processor 602 to generate user interface display images including media asset identifiers representing at least one of media asset class, at least one media asset sub-class, and media asset elements in respective ones of the at least one media asset sub-class. The UI generator 608 generates this UI using the formatting information generated by the access processor 602 as discussed above. In various embodiments, the UI generator 608 may generate the formatting information using information provided from the access processor 602. The UI generates the display image and outputs the generated user interface display image including at least one data field enabling user entry of data to at least one of the display interface 218 for display on display device 114 (FIG. 1), the user interface for output to the user input device 300b (FIG. 3B), and a touch panel interface for output to a touch sensitive display device 300a (FIG. 3A). From these different interfaces, a user may view and interact with the various media assets including information identifying categories of media assets and the level of access that a user has to the individual media assets in the category. In various embodiments, when the UI is displayed on a display device via the display interface 218, the user may employ remote control 300b to navigate among the media assets in the UI using navigation buttons and/or alphanumeric keys of the remote control 300b. In various embodiments, if the display device 114 is a touch sensitive display device, a user may select and/or interact with various media assets by touching a position on the screen associated with the media asset and entering the data using one of a gesture based input and/or a virtual keyboard that is also selectively displayed either within the UI or overlaid on the UI. This manner of inputting data into data fields is also applicable if the device on which the UI is output is a touch sensitive display device 300a.

In various embodiments, the receiving device 504 may include a communication interface 610 coupled to the access processor 602. The communication interface 610 enables the receiving device 504 to communicate with a third party electronic device able to receive electronic communications. The communication interface 610 may include any type of communication protocol enabling communication with at least one of, but not limited to, a cellular network, Wi-Fi network, wired network, and the Internet. In various embodiments, the access processor 602 can periodically communicate information about a level of access associated a respective media asset class, sub-class or element of a sub-class to the user thereby notifying the user if the previously determined level of access has changed. For example, in response to determining that a rental period for an element of a particular media asset sub-class is about to expire, (e.g., below a threshold value—less than 24 hours), the access processor 602 may generate a notification message notifying a user about the time remaining to access that particular media asset. The notification message (e.g., email, text message, etc.) may be provided to the communication interface 610 for communication to a third party device (e.g., personal computer, cellular phone, tablet, etc.). In various embodiments, the memory 606 may include user profile data including rules defining when a notification message is to be generated. The user profile data may also specify the manner by which the communication interface 610 is to communicate the notification message including, but not limited to, cellular phone call, email message, text message, and an API that provides a notification message to an application executing on a computing device.

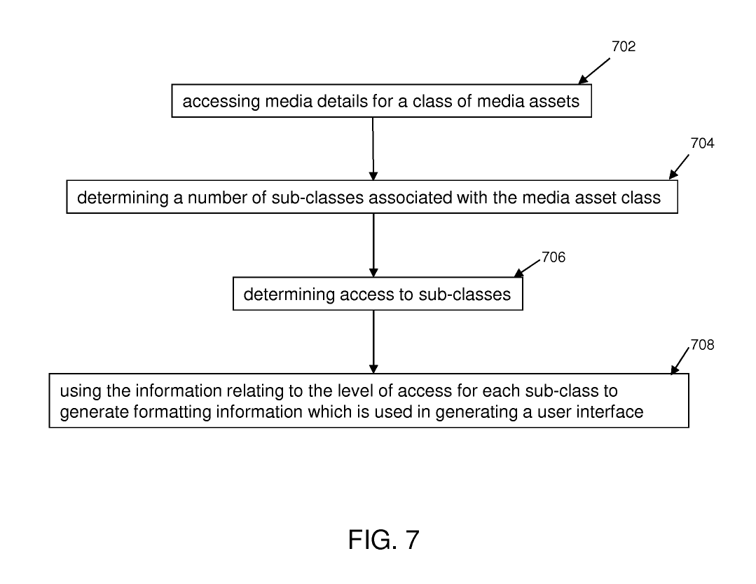

FIG. 7 is a flow diagram detailing an algorithm executed by the access processor 602 in accordance with various embodiments. In step 702, media asset information associated with at least one media asset is accessed. In various embodiments, the accessing is performed based on input from a user interface generated by the UI generator 608 and enables the media details to be accessed for media assets that are stored locally or remotely via a network. Further, the accessing may be, for example, by push or pull mechanisms. The media details can be accessed from a database and can include, for example, poster art and the descriptive text. The identifier for the media asset can be generated based on information contained in the media details. In step 704, the access processor 602 determines a number of sub-classes associated with the media asset class located in step 702. For example, if the media asset class is a television series, the number of sub-classes may represent a number of seasons for the particular television series such that each sub-class is rendered in advance or on the fly. In various embodiments, in addition to sub-class determination, step 704 also determines the individual elements of each sub-class, which as described above, can represent individual episodes of a particular season. The sub-class and element information may be stored in a database in memory 606, for example. In step 706, the sub-classes (e.g., seasons) to which the user has access are determined. This determination may occur in the background prior to rendering in a UI. In various embodiments, the determination in step 706 may include querying a local device based on configuration information that identifies local devices that store media asset content, to identify the content associated with the media asset class and sub-class that is available. In various embodiments, step 706 includes querying content associated with the determined media asset class and sub-class located on a network using network configuration information. Further, step 706 may also include querying each media service that a user subscribes to in order to identify the sub-classes associated with the media asset class. In step 708, the access processor 602 uses the information determined in step 706 relating to the level of access for each sub-class to generate formatting information which is used in generating a user interface including identifiers associated with the determined media asset class and subclass that have been visually modified to provide information to the user regarding the level of access that the user has to the particular sub-class (or elements within the subclass.

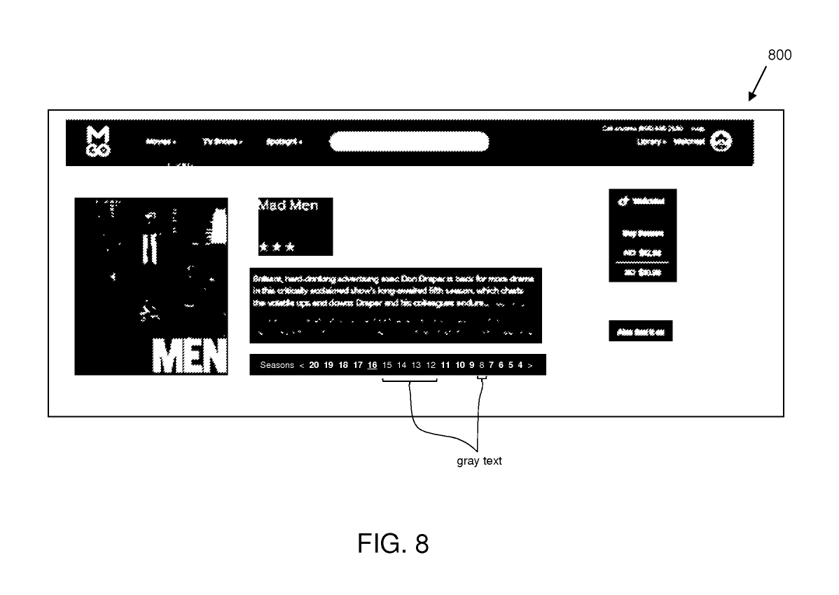

FIG. 8 is a user interface 800 generated by the UI generator 608 using the format information to identify, to a user, a level access associated with respective sub-classes of a particular media asset class according to various embodiments. The UI 800 of FIG. 8 represents an example where the media asset class is a television series and the sub-classes represent various seasons of the series. This is shown for purpose of example only and any media asset class determined by any characteristic that groups media assets may be used. This includes, for example, where a movie is a particular media asset class and the sequels to the movie are the sub-classes. Other examples of media asset classes, sub-classes and elements of sub-classes having a hierarchical structure set forth above can be readily apparent to persons skilled in the art.

The UI 800 advantageously presents to a user a class of media assets which, in this embodiment, is the television series “MAD MEN” and allows a user to select between different sub-classes (e.g., seasons) of the series. The access processor 602 has determined the level of access to each of the sub-classes (e.g., seasons) and generated formatting information that is used by UI generator 608 to generate UI 800. The formatting information includes modifying a visual cue of the identifiers associated with sub-classes to which the user has access. For example, the interface displays in a first color the seasons to which a user has access. Typically, access is provided because the user has purchased the season, but the user may alternatively, for example, have rented, borrowed, or been given access to (for example, through a lottery or promotion). The formatting information includes modifying a visual cue of the identifiers associated with sub-classes (e.g., seasons) that the user cannot access. For example, the user interface displays in a second color the seasons to which a user does not have access. For those “second color” seasons, the user would need, for example, to purchase or rent those seasons in order to gain access. In various embodiments, by selecting an image element representative of the identifier, the user is automatically brought to a UI that can enable the user to purchase or otherwise gain access to those sub-classes by completing an access agreement for accessing those sub-classes.

The seasons (sub-classes) are accessed, in this implementation, by using a control interface to operate a cursor to select the respective seasons. Other interfaces use mechanisms other than a cursor, such as, for example, by simply highlighting selected elements of the display. Additionally, touch navigation using a touch screen device may also enable the user to access the various sub-classes or initiate a process by which access to inaccessible sub-classes can occur.

In FIG. 8, UI 800 displays seasons 4-7, 9-11, and 16-20 in bold white. UI 800 displays seasons 8 and 12-15 in gray (shown in FIG. 8 by the label “gray text”). Thus, the user is shown to have access to seasons 4-7, 9-11, and 16-20 (the “white-colored” seasons), but the user does not have access to seasons 8 and 12-15 (the “gray-colored” seasons). In this embodiment, season 16 is also underlined in FIG. 8, indicating that the user has selected season 16 as an “active season” and that the user has access to that season.

In various embodiments, the formatting information generated by the access processor 602 may provide different distinctions among seasons depending on what function the user is performing. In one such implementation, if the user is searching for content and the search returns a particular program, the system will display in one mode (for example, highlighted or bolded text) all of the seasons that are available for purchase (to own, rent, etc.) through the system (or its partners). The system will, in this implementation, display all of the other seasons in a different mode (for example, non-bolded or non-highlighted). Thus, for example, if 5 seasons exist for the program, and only the last three seasons are available for purchase, then the system displays “1” and “2” in non-bolded text, and displays “3”, “4”, and “5” in bolded text.

Continuing with this embodiment, if the user accesses the user's library holdings, then the system provides a different distinction among the seasons. If the user already owns season 4 (and only season 4), then the system will display “4” in bolded text, and display “1”, “2”, “3”, and “5” in non-bolded text. This communicates to the user the fact that the user already owns season 4. If the user wants to purchase season 3, for example, then the system will provide the user an opportunity to do so. For example, the user can click the “3”, and the system will allow provide a mechanism by which the user can purchase season 3.

Various embodiments may provide a plurality of distinctions among sub-classes (e.g., seasons). For example, three or four distinctions, or more, can be provided. These distinctions can be provided using, for example, color, size, brightness, or other visual, or auditory, indicators, or their combinations. For example, the system may distinguish between seasons that exist, seasons that are available for purchase, and seasons that the user already owns. Other categories of distinction include, for example, seasons that the user owns forever, seasons that the user has rented for a limited period of time, seasons that the user only has the right to view a limited number of times, etc. In various embodiments, when a user performs a search, or when the user accesses the users library, the system displays in bold and with a slightly larger font the seasons that the user owns, displays in a bright color (but not bolded) and with a regular font size (not with the larger font size) the seasons that the user can purchase but does not own yet, and displays in a subdued color (not bright, and not bolded) and in the regular font size (not the larger font size) the seasons that are not available for purchase and not owned by the user.

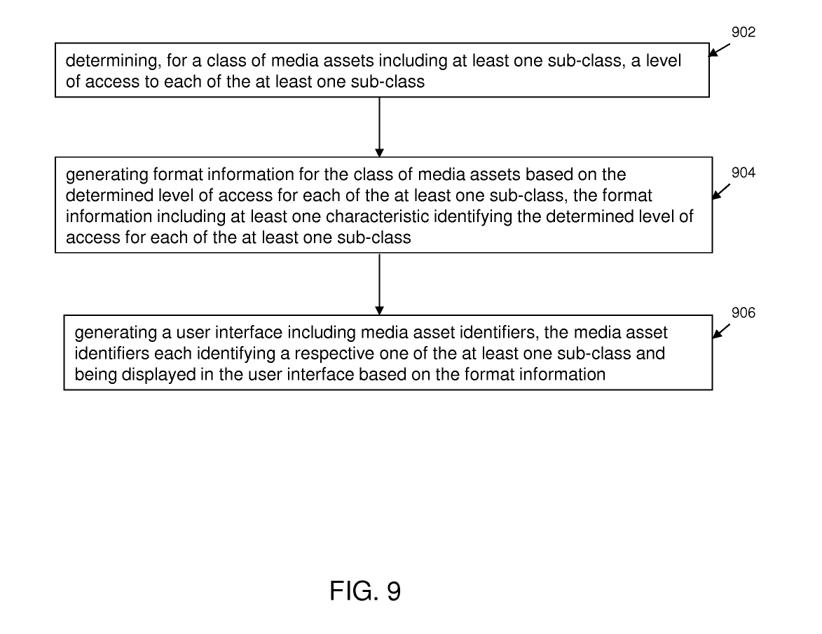

FIG. 9 is an algorithm describing the operation of the system according to various embodiments. The algorithm provides a method of displaying information in a user interface. In step 902, an access processor (602 in FIG. 6) determines, for a class of media assets including at least one sub-class, a level of access to each of the at least one sub-class. In step 904, the access processor 602 generates format information for the class of media assets based on the determined level of access for each of the at least one sub-class, the format information including at least one characteristic identifying the determined level of access for each of the at least one sub-class. In various embodiments, each of the at least one characteristic represents a respective level of access and each level of access is associated in the user interface using a respective visual indicator.

In another embodiment, step 904 further includes searching at least one of a local storage medium and a network connected storage medium to locate respective sub-classes of the class of media assets and for each located sub-class, identifying a level of access associated with each of the located sub-classes. In another embodiment, step 904 may also include periodically searching to determine if a level access for each of the at least one subclass has changed and updating the format information for respective sub-class for which the level of access is determined to have changed. In another embodiment, step 904 may include identifying if a user has accessed any of the at least one sub-class and the at least one characteristic of the format information includes indicia identifying an amount of each of the at least one sub-class the user has accessed.

In step 906, a user interface generator (608 in FIG. 6) generates a user interface including media asset identifiers, the media asset identifiers each identifying a respective one of the at least one sub-class and being displayed in the user interface based on the format information. In another embodiment, the access processor 602 generates a message indicating a level of access for a respective sub-class is determined to have changed and communicates the message to a user via a communication interface. In various embodiments, the access processor generates a message indicating the availability of a respective sub-class has changed and communicating the message to a user via the communication interface. In another embodiment, the access processor 602 generates a message indicating the availability of a respective sub-class has changed and communicating the message to a user via the communication interface.

It should be noted that variations of the foregoing embodiments are contemplated and are considered to be within the scope of the disclosure. Additionally, features and aspects of described embodiments may be adapted for other implementations. It should be noted that the above embodiments may be implemented individually or in any combination with one another, as one skilled in the art would understand.

Several of the embodiments refer to features that are automated or that are performed automatically. Variations of such embodiments, however, may be performed manually (i.e., not automated) and/or may not perform all of part of the features automatically.

Reference to “various embodiments” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in various embodiments” or “in an embodiment” or “in one implementation” or “in an implementation”, as well any other variations, appearing in various places throughout the specification are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, memory), storing the information, processing the information, transmitting the information, moving the information, copying the information, erasing the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

This application refers to “encoders” and “decoders” in a variety of implementations. It should be clear that an encoder can include, for example, one or more (or no) source encoders and/or one or more (or no) channel encoders, as well as one or more (or no) modulators. Similarly, it should be clear that a decoder can include, for example, one or more (or no) modulators as well as one or more (or no) channel encoders and/or one or more (or no) source encoders.

It is to be appreciated that the use of “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C” and “at least one of A, B, or C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Additionally, many implementations may be implemented in a processor, such as, for example, a post-processor or a pre-processor. The processors discussed in this application do, in various implementations, include multiple processors (sub-processors) that are collectively configured to perform, for example, a process, a function, or an operation. Additionally, various components include a processor and/or perform processing functions. Indeed, various components include multiple sub-processors that are collectively configured to perform the operations of that component. Such components include, for example, an encoder, a decoder, a display engine, a remote control interface module, a transmitter, and a receiver.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware.

The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants (“PDAs”), and other devices that facilitate communication of information between end-users.

Implementations of the various processes and features described herein may be embodied in a variety of different equipment or applications. Examples of such equipment include an encoder, a decoder, a post-processor, a pre-processor, a video coder, a video decoder, a video codec, a web server, a television, a set-top box, a router, a gateway, a modem, a laptop, a personal computer, a tablet, a cell phone, a PDA, a remote control, and other communication devices. As should be clear, the equipment may be mobile and even installed in a mobile vehicle. Further, such equipment typically includes or interfaces to a display device of some sort, including for example, a screen of a computer or laptop, a tablet screen, a television screen, and a smart phone screen.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc, or a Blu-Ray Disc™), a random access memory (“RAM”), a read-only memory (“ROM”), a USB thumb drive, or some other storage device. The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading syntax, or to carry as data the actual syntax-values generated using the syntax rules. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method of displaying information in a user interface, the method comprising:
determining, for a class of media assets including at least one sub-class, a level of access to each of the at least one sub-class;
generating format information for the class of media assets based on the determined level of access for each of the at least one sub-class, the format information including at least one characteristic identifying the determined level of access for each of the at least one sub-class; and
generating a user interface including media asset identifiers, the media asset identifiers each identifying a respective one of the at least one sub-class and being displayed in the user interface based on the format information.

2. The method of claim 1, wherein each of the at least one characteristic represents a level of access.

3. The method of claim 1, wherein the class of media assets includes a program series, and each of the at least one sub-class identifies a season of the respective program series.

4. The method of claim 1, wherein the activity of determining includes
searching at least one of a local storage medium and a network connected storage medium to locate respective sub-classes of the class of media assets, and
for each located sub-class, identifying a level of access associated with each of the located sub-classes.

5. The method according to claim 1, wherein each level of access is associated in the user interface using a respective visual indicator.

6. The method according to claim 1, further comprising:
periodically searching to determine if a level access for each of the at least one subclass has changed; and
updating the format information for respective sub-class for which the level of access is determined to have changed.

7. The method according to claim 1, further comprising:
generating a message indicating a level of access for a respective sub-class is determined to have changed; and
communicating the message to a user.

8. The method according to claim 1, wherein
determining a level of access identifies an availability of each of the at least one sub-class.

9. The method according to claim 8, further comprising:
generating a message indicating the availability of a respective sub-class has changed; and
communicating the message to a user.

10. The method according to claim 1, further comprising:
identifying if a user has accessed any of the at least one sub-class, wherein the at least one characteristic of the format information includes indicia identifying an amount of each of the at least one sub-class the user has accessed.

11. An apparatus for displaying information in a user interface, the apparatus comprising:
an access processor that determines, for a class of media assets including at least one sub-class, a level of access to each of the at least one sub-class and that generates format information for the class of media assets based on the determined level of access for each of the at least one sub-class, the format information including at least one characteristic identifying the determined level of access for each of the at least one sub-class; and
a user interface generator that generates a user interface, the user interface including media asset identifiers, the media asset identifiers each identifying a respective one of the at least one sub-class and being displayed in the user interface based on the format information.

12. The apparatus of claim 11, wherein each of the at least one characteristic represents a respective level of access.

13. The apparatus of claim 11, wherein the class of media assets includes a program series and each of the at least one sub-class identifies a season of the respective program series.

14. The apparatus of claim 11, wherein the access processor searches at least one of a local storage medium and a network connected storage medium to locate respective sub-classes of the class of media assets and for each located sub-class, identifies a level of access associated with each of the located sub-classes.

15. The apparatus according to claim 11, wherein each level of access is associated in the user interface using a respective visual indicator.

16. The apparatus according to claim 11, wherein the access processor periodically searches to determine if a level access for each of the at least one subclass has changed and updates the format information for respective sub-class for which the level of access is determined to have changed.

17. The apparatus according to claim 11, further comprising:
a communication interface, wherein said access processor generates a message indicating a level of access for a respective sub-class is determined to have changed and communicates the message to a user via the user interface.

18. The apparatus according to claim 1, wherein the access processor determines a level of access by identifying an availability of each of the at least one sub-class.

19. The apparatus according to claim 18, further comprising:
a communication interface, wherein said access processor generates a message indicating the availability of a respective sub-class has changed and communicates the message to a user via the communication interface.

20. The apparatus according to claim 11, wherein the access processor identifies if a user has accessed any of the at least one sub-class and generates the at least one characteristic of the format information including indicia identifying an amount of each of the at least one sub-class the user has accessed.
